(19) United States
(12) Patent Application Publication
(10) Pub. No.: US 2014/0090485 A1
(43) Pub. Date: Apr. 3, 2014

(54) MEMS Pressure Sensor Assembly

(71) Applicant: ROBERT BOSCH GMBH, Stuttgart (DE)

(72) Inventors: Ando Lars Feyh, Palo Alto, CA (US); Gary O'Brien, Palo Alto, CA (US)

(73) Assignee: Robert Bosch GmbH, Stuttgart (DE)

(21) Appl. No.: 13/633,619

(22) Filed: Oct. 2, 2012

(51) Int. Cl. G01L 1/20

(52) U.S. Cl. 73/862.68

(57) ABSTRACT

A pressure sensor assembly includes a first die assembly, a second die assembly, and a conducting member. The first die assembly includes a MEMS pressure sensor. The second die assembly includes an ASIC configured to generate an electrical output corresponding to a pressure sensed by the MEMS pressure sensor. The conducting member is positioned between the first die assembly and the second die assembly and is configured and to electrically connect the MEMS pressure sensor to the ASIC.

### FIELD

This disclosure relates generally to semiconductor devices and particularly to a microelectromechanical system (MEMS) pressure sensor.

### BACKGROUND

Microelectromechanical systems (MEMS) have proven to be effective solutions in various applications due to the sensitivity, spatial and temporal resolutions, and lower power requirements exhibited by MEMS devices. Consequently, MEMS-based sensors, such as accelerometers, gyroscopes, acoustic sensors, optical sensors, and pressure sensors, have been developed for use in a wide variety of applications.

MEMS pressure sensors are often packaged in either a ceramic or a pre-mold package. Ceramic and pre-mold packages function well to contain MEMS pressure sensors. For some sensor applications, however, these types of packages are simply too large. For example, the package may define a substrate contact area that exceeds the area available for mounting the pressure sensor. Also, the package may exceed a height limitation of the sensor application, especially when wire bonds are used to electrically connect the package to the circuit/sensor. Additionally, ceramic and pre-mold packages are typically expensive to manufacture compared to some other packaging approaches.

Therefore, in an effort to make MEMS pressure sensors usable in even more sensor applications, it is desirable to reduce the size of the package and also the cost to package MEMS pressure sensors.

### SUMMARY

According to one embodiment of the present disclosure, a sensor assembly includes a first die assembly, a second die assembly, and a conducting member. The first die assembly includes a MEMS sensor. The second die assembly includes an ASIC configured to generate an electrical output corresponding to a pressure sensed by the MEMS sensor. The conducting member is positioned between the first die assembly and the second die assembly and is configured and to electrically connect the MEMS sensor to the ASIC.

According to another embodiment of the present disclosure, a sensor assembly includes a first die assembly and a second die assembly. The first die assembly includes a MEMS sensor. The second die assembly includes an ASIC configured to generate an electrical output corresponding to a pressure sensed by the MEMS sensor. The ASIC is electrically connected to the MEMS sensor. The first die assembly is attached to the second die assembly in a stacked configuration.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a perspective view of a MEMS sensor assembly, as described herein; and

FIG. 2 is a cross-sectional view taken along line II-II of FIG. 1.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

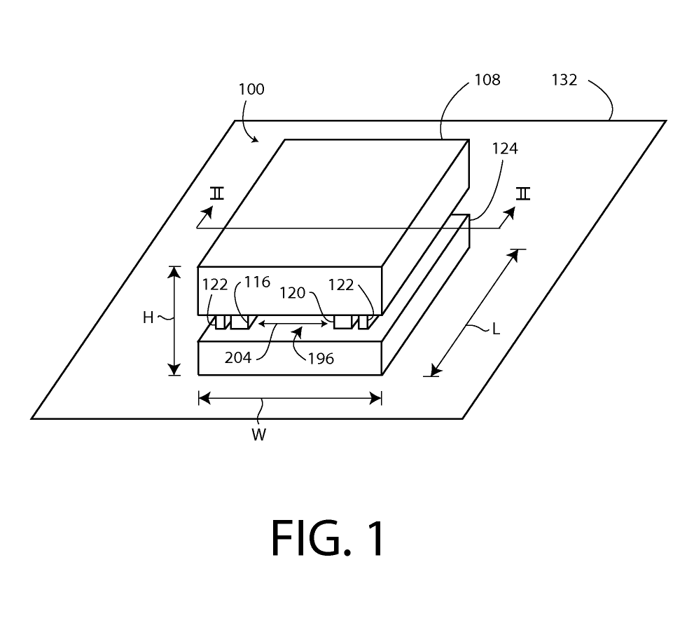

As shown in FIG. 1, a pressure sensor assembly 100 includes an upper die assembly 108, a conducting member 116, a conducting member 120, a bonding member 122, and a lower die assembly 124. The pressure sensor assembly 100 is shown positioned on a substrate 132, such as a printed circuit board or any other substrate that is suitable for mounting electrical components.

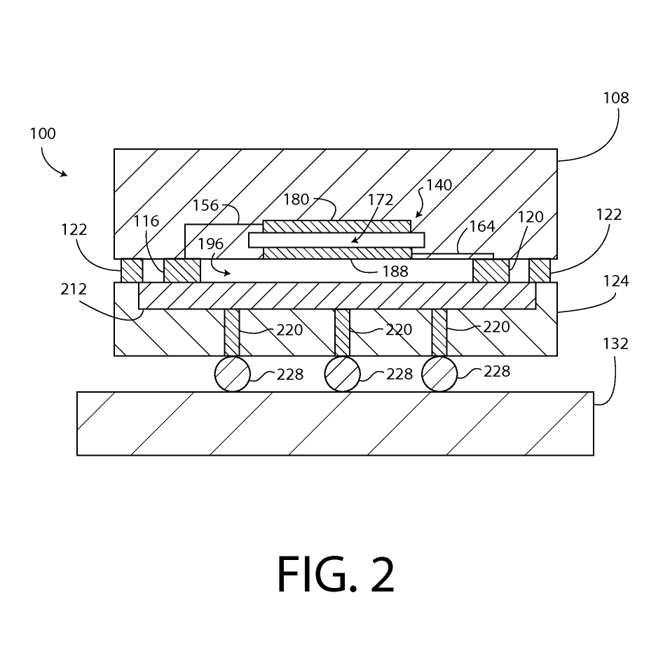

With reference to FIG. 2, the upper die assembly 108 is formed from silicon and includes a MEMS pressure sensor 140. The pressure sensor 140 is a capacitive pressure sensor that defines a cavity 172 and includes an upper electrode 180 and a membrane 188 that is movable with respect to the upper electrode. The membrane 188 is preferably made of epitaxial silicon.

The upper electrode 180 is defined in the upper die assembly 108 and is formed by doping a portion of the upper die assembly. Alternatively, the upper electrode 180 is formed by using a doped silicon layer on an insulating film above the substrate of the upper die assembly 108. The area of the upper electrode 180 is approximately 0.01 to 1 square millimeter (0.01-1 mm²). An electrical lead 156 connects the upper electrode 180 to the conducting member 116.

The membrane 188 is positioned beneath the cavity 172 defined by the upper die assembly 108. The membrane 188 includes an electrode defined therein. The area of the membrane 188 is approximately 0.01-1 square millimeter (0.01-1 mm²). The membrane 188 is spaced apart from the upper electrode 180 by approximately 1 micrometer (1 μm). An electrical lead 164 connects the membrane 188 to the conducting member 120. The epitaxial silicon membrane 188 in combination with the capacitive transduction principle makes the pressure sensor 140 mechanically robust, as compared to other types of pressure sensors. The thickness of 188 is about 1-20 um.

The cavity 172 of the pressure sensor 140 is typically at or near vacuum; accordingly, the pressure sensor is an absolute pressure sensor. In other embodiments, the cavity 172 is at a pressure level other than at or near vacuum, depending on the operating environment of the pressure sensor assembly 100, among other factors.

The conducting members 116, 120 are positioned between the upper die assembly 108 and the lower die assembly 124. The conducting member 116 is electrically isolated from the conducting member 120. The conducting members 116, 120 electrically connect the upper die assembly 108 to the lower die assembly 124. To this end, the conducting member 116 is positioned to make electrical contact with the electrical lead 156, and the conducting member 120 is positioned to make electrical contact with the electrical lead 164. Additionally, the conducting members 116, 120 make electrical contact with the lower die assembly 124. The conducting members 116, 120 are formed from solder or any metal or conductive material.

The bonding member 122 structurally connects the upper die assembly 108 to the lower die assembly 124 in a stacked configuration using a eutectic bonding procedure. The bonding member 122 spaces the upper die assembly 108 apart from the lower die assembly 124, such that a cavity 196 is defined between the upper die assembly and the lower die assembly. A gap 204 (FIG. 1) between the conducting members 116, 120 and the bonding member 122 exposes the cavity 196 to atmosphere (or to the fluid surrounding the pressure assembly 100). It is noted that in another embodiment, the structural connection of the upper die assembly 108 to the lower die assembly 124 is accomplished through a thermo-compression bonding procedure. In yet another embodiment, the structural connection of the upper die assembly 108 to the lower die assembly 124 is accomplished through solid-liquid-interdiffusion bonding or through metallic soldering, gluing, and/or using solder balls. In a further embodiment, the bonding member 122 and the conducting members 116, 120 are applied to the lower die assembly 124 (or the upper die assembly 108) during the same fabrication step when forming the pressure sensor assembly 100.

The lower die assembly 124 is formed from silicon. The lower die assembly 124 includes an ASIC 212 and defines a plurality of through silicon vias 220. The ASIC 212 is electrically connected to the pressure sensor 140 through the conducting members 116, 120. The ASIC 212 generates an electrical output that corresponds to a pressure sensed by the pressure sensor 140. As shown in FIGS. 1 and 2, the “footprint” of upper die assembly 108 is approximately equal to the footprint of the lower die assembly 124. In another embodiment, the footprint of the upper die assembly 108 is sized differently (either smaller or larger) than the footprint of the lower die assembly 124.

The through silicon vias 220 convey the electrical output of the pressure sensor assembly 100. Additionally, the through silicon vias 220 may receive electrical signals from an external circuit (not shown), such as signals for configuring the ASIC 212. The pressure sensor assembly 100 is shown as including three of the through silicon vias 220, it should be understood, however, that the lower die assembly 124 includes as many of the through silicon vias as is used by the ASIC 212.

The pressure sensor assembly 100 is connectable directly to the substrate 132 without being mounted in a separate package. This mounting scheme is often referred to as a bare-die mounting/connection scheme. Since the pressure sensor assembly 100 is not mounted in a ceramic or pre-mold package, the manufacturing costs of the pressure sensor assembly are typically less than the manufacturing costs associated with conventional packaged pressure sensor assemblies.

As shown in FIG. 2, solder balls 228 are used to structurally and electrically connect the pressure sensor assembly 100 to the substrate 132. The solder balls 228 are positioned to make electrical contact with the through silicon vias 220, in a process known to those of ordinary skill in the art.

With reference again to FIG. 1, the pressure sensor assembly 100 defines a length L, a width W, and a height H. Since the pressure sensor assembly 100 is not mounted in a package it exhibits a comparatively small size as compared to other package-mounted pressure sensor assemblies. In particular, the contact area of the pressure sensor assembly 100 that is positioned against the substrate 132 is less than approximately two square millimeters (2 mm²). The contact area (also referred to as a “footprint”) is equal to the length L times the width W of the pressure sensor assembly 100. Additionally, the height H of the pressure sensor assembly is less than approximately one millimeter (1 mm). It is noted that the height H is less than 1 mm even when the pressure sensor assembly 100 is electrically connected to the substrate 132, since wire bonds are not used to electrically connect the pressure sensor assembly. As the sensitive membrane 188 is facing the ASIC 212, there is also no protective housing needed (package is protection itself).

In operation, the pressure sensor assembly 100 senses the pressure of the fluid (not shown) surrounding the pressure sensor assembly. In particular, the pressure sensor assembly 100 exhibits an electric output that corresponds to the pressure imparted on the membrane 188 by the fluid in the cavity 196, as described below.

The pressure of the fluid in the cavity 196 causes the membrane 188 to move relative to the electrode 180. This is because the cavity 196 is fluidly connected to the environment/atmosphere, since the connecting members 116, 120 and the bonding member 122 do not form a closed perimeter. Typically, an increase in pressure causes the membrane 188 to move closer to the electrode 180. This movement results in a change in capacitance between the electrode 180 and the membrane 188.

The ASIC 212 exhibits an electrical output signal that is dependent on the capacitance sensed between the electrode 180 and the membrane 188. The electrical output signal of the ASIC 212 changes in a known way in response to the change in capacitance between the electrode 180 and the membrane 188. Accordingly, the electrical output signal of the ASIC 212 corresponds to the pressure exerted on the membrane 188 by the fluid in the cavity 196.

The comparatively small size of the pressure sensor assembly 100 makes it particularly suited for consumer electronics, such as mobile telephones and smart phones. Additionally, the robust composition of the pressure sensor assembly 100 makes it useful in automotive applications, such as tire pressure monitoring systems, as well as any application in which a very small, robust, and low cost pressure sensor is desirable. Furthermore, the pressure sensor assembly 100 may be implemented in or associated with a variety of applications such as home appliances, laptops, handheld or portable computers, wireless devices, tablets, personal data assistants (PDAs), MP3 players, camera, GPS receivers or navigation systems, electronic reading displays, projectors, cockpit controls, game consoles, earpieces, headsets, hearing aids, wearable display devices, security systems, and etc.

In an alternative embodiment of the pressure sensor assembly 100, the pressure sensor assembly is mounted to the substrate 132 in an inverted orientation with the upper die assembly 108 positioned against the solder balls 228 and the substrate. In this embodiment, the through silicon vias 220 are formed in the upper die assembly 108 and are electrically connected to the ASIC 212 through at least the conducting members 116, 120.

Also in another embodiment of the pressure sensor assembly 100, the upper die assembly 108 includes a gel or a polymer coating (not shown). The gel or the polymer coating protects the epitaxial silicon membrane 188.

Furthermore, in some embodiments, the pressure sensor assembly 100 is coated by a conformal coating process. The coating (not shown) protects the pressure sensor assembly 100 against harsh environments. The coating is applied to the pressure sensor assembly 100, in some of the embodiments, by atomic layer deposition. The coating applied to the pressure sensor assembly 100 is formed from materials including, but not limited to, Al203, HfO2, ZrO2, SiC, parylene, and combinations thereof.

In another embodiment of the pressure sensor assembly 100, the connecting members 116, 120 electrically connect the upper die assembly 108 to the lower die assembly 124 and also structurally connect the upper die assembly to the lower die assembly in the stacked configuration. Accordingly, in this embodiment, a separate bonding member 122 is not included since the connecting member 116 and the connecting member 120 perform both the electrical and structural connection.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A pressure sensor assembly comprising:
a first die assembly including a MEMS pressure sensor;
a second die assembly including an ASIC configured to generate an electrical output corresponding to a pressure sensed by said MEMS pressure sensor; and
a conducting member positioned between said first die assembly and said second die assembly and configured and to electrically connect said MEMS pressure sensor to said ASIC.

2. The pressure sensor assembly of claim 1, wherein said MEMS pressure sensor includes a capacitive pressure sensor.

3. The pressure sensor assembly of claim 2, wherein said capacitive pressure sensor includes an epitaxial silicon membrane.

4. The pressure sensor assembly of claim 1, wherein said second die assembly is configured for a bare-die connection to a substrate.

5. The pressure sensor assembly of claim 1, wherein:
the pressure sensor assembly defines a length and a width,
said length times said width equals an area, and
said area is less than about two square millimeters.

6. The pressure sensor assembly of claim 1, wherein a cavity is defined between said first die assembly and said second die assembly.

7. The pressure sensor assembly of claim 6, further comprising:
a bonding member positioned between said first die assembly and said second die assembly and configured to space said first die assembly apart from said second die assembly.

8. The pressure sensor assembly of claim 6, wherein said cavity is exposed to atmosphere.

9. The pressure sensor assembly of claim 1, wherein said second die assembly defines a plurality of through silicon vias.

10. A pressure sensor assembly comprising:
a first die assembly including a MEMS pressure sensor; and
a second die assembly including an ASIC configured to generate an electrical output corresponding to a pressure sensed by said MEMS pressure sensor, said ASIC being electrically connected to said MEMS pressure sensor,
wherein said first die assembly is attached to said second die assembly in a stacked configuration.

11. The pressure sensor assembly of claim 10, wherein a cavity is defined between said first die assembly and said second die assembly.

12. The pressure sensor assembly of claim 11, further comprising:
a bonding member positioned between said first die assembly and said second die assembly and configured to space said first die assembly apart from said second die assembly.

13. The pressure sensor assembly of claim 11, further comprising:
a conducting member positioned between said first die assembly and said second die assembly and configured (i) to electrically connect said MEMS pressure sensor to said ASIC and (ii) to space said first die assembly apart from said second die assembly.

14. The pressure sensor assembly of claim 13, wherein said conducting member electrically connects said MEMS pressure sensor to said ASIC with solder.

15. The pressure sensor assembly of claim 11, wherein said cavity is exposed to atmosphere.

16. The pressure sensor assembly of claim 10, wherein said MEMS pressure sensor includes a capacitive pressure sensor.

17. The pressure sensor assembly of claim 16, wherein said capacitive pressure sensor includes an epitaxial silicon membrane.

18. The pressure sensor assembly of claim 10, wherein said second die assembly is configured for a bare-die connection to a substrate.

19. The pressure sensor assembly of claim 10, wherein:
the pressure sensor assembly defines a length and a width,
said length times said width equals an area, and
said area is less than about two square millimeters.

20. The pressure sensor assembly of claim 10, wherein said second die assembly defines a plurality of through silicon vias.
